(19) United States
(12) Patent Application Publication
(10) Pub. No.: US 2004/0209595 A1
(43) Pub. Date: Oct. 21, 2004

(54) Apparatus and method for monitoring the time usage of a wireless communication device

(76) Inventor: Joseph Bekanich, Bear Creek, PA (US)

Correspondence Address: MCDERMOTT WILL & EMERY LLP, 600 13TH STREET, N.W., WASHINGTON, DC, 20005-3096, US

(21) Appl. No.: 10/669,628

(22) Filed: Sep. 25, 2003

Related U.S. Application Data
(63) Continuation of application No. 10/253,715, filed on Sep. 25, 2002.
(60) Provisional application No. 60/485,128, filed on Jul. 8, 2003.

(51) Int. Cl. H04M 11/00

(52) U.S. Cl. 455/405; 455/407; 455/556.2

(57) ABSTRACT

A method and apparatus for monitoring usage and activity of a wireless communication device, including a wireless telephone and a PDA device. The method and apparatus provide for detecting and monitoring each communication and displaying the remaining units available to the operator under their billing plan for the detected type of communication. Historical usage of each type of communication is maintained, and a plurality of types of available remaining communication units may be simultaneously displayed. The wireless device may monitor the usage of a type of communication and provide an alarm to the operator when less than a predetermined number of units, such as minutes or data bytes, are available to be used by the communication device in the billing period. The wireless device may also prompt the operator to call their service provider to request additional units.

This application is a continuation in part of U.S. Ser. No. 10/253,715 filed on Sep. 25, 2002, and claims the benefit of Provisional application 60/485,128 filed on Jul. 8, 2003, each of these applications are herein incorporated by reference in their entirety.

### BACKGROUND OF THE INVENTION

This disclosure relates generally to wireless communication systems and more particularly to apparatus and method for monitoring and displaying time usage data for a cellular mobile communication device during a billing period.

Mobile cellular phone technology is one of the fastest growing sectors of today's global economy, and it is expected that the use of cell phones will continue to grow dramatically in the future. Subscribers to cell phone service generally choose from a number of monthly billing packages offered by the cell phone service providers, and those billing packages normally include a combination of various services which are geared to particular customer needs. For example, a billing plan may offer a certain amount of free time within a local area, a certain amount of free time of long distance calling out of the local area, reduced rates for different times of the day, graduated rates based upon volume usage and so forth.

A typical mobile telephone service provides an air interface from one or more base stations to appropriately equipped cellular telephones or the like. Such a network provides connectivity between cellular telephones as well as between such telephones and telephones or other landline equipment connected to the public switched telephone network (PSTN). More modern cellular or PCS (personal communication service) networks also provide data connectivity to the Internet (or to intranets). The data connectivity allows mobile customers to access e-mail, web pages and the like. The data connectivity may also allow communications with home or office computers either directly or via an exchange of messages through an intermediate server.

Several carriers operate wireless data networks. In such a network, a device such as a PDA or laptop/handheld computer has an appropriate transceiver or interface card. Here, the wireless service provider maintains a public wireless access point (AP), which provides the air interface for wireless data communications. The carrier network provides packet switched data connectivity to the Internet (or to intranets), to access various applications on servers and/or to communicate with other end user equipment as outlined in the discussion of cellular communications. The wireless data services, however, typically provide much higher bandwidth/bit rates.

Wireless communications to and/or from these various types of mobile devices, if provided by public carriers, incur subscription charges, which typically include usage based charges. In cellular or PCS type services, these usage charges are time based and often referred to as “air time minutes.” The service usage for data services provided by cellular or packet data service carriers may be billed based on similar measures of time, or the carrier(s) may bill for such data service usage based on other measures, such as numbers of packets.

Subscribers incur substantial expenses from over usage billing of their accounts through exceeding the usage time allowed by their basic billing plans. Clearly, a cell phone subscriber has a primary interest in tracking the amount of time his telephone is in use so as to avoid exceeding the time usage permitted under the basic billing plan and thereby avoid unexpected high monthly bills due to that over usage time, which is normally billed at the highest rates.

It may be to the advantage of the cellular service provider not to afford the time usage monitoring function on the cell phones since, a substantial part of their income may be derived from the over usage billing by subscribers who have no idea what the status of their time usage is when they are exceeding the time allotted by their basic billing plan. Cellular service providers have a significant influence over the cell phone manufacturers and this may explain why the cell phones themselves, when originally manufactured. are not programmed to provide any total time or over usage information to the subscriber.

U.S. Pat. No. 5,684,861 discloses a rather complex, costly system for monitoring time usage of a cell phone but, to applicant's knowledge, neither that system nor any other system has been successfully commercialized.

### SUMMARY OF THE INVENTION

The total time monitoring system, as described herein below, was developed to satisfy the needs of the subscriber as discussed above.

An apparatus for monitoring usage of a wireless device may comprise: a transmitter/receiver capable of transmitting and receiving a plurality of data signals; a microprocessor connected to the transmitter/receiver and configured to detect a device event, and provide monitoring information indicative of the usage of the wireless communication device during the occurrence of the detected device event; and a display capable of continuously displaying the monitoring information during the device event and after the end of the device event.

In the apparatus, the microprocessor may be configured to provide historical information indicative of the usage of the wireless communication device associated with a plurality of predetermined types of device events and instruct the display to continuously display the historical information of at least one type of device event of the plurality of predetermined types of device events.

In the apparatus, the microprocessor may be configured to receive instructions from an operator of the wireless device to selectively remove historical information of a device event from the display and provide instructions to the display to selectively remove the historical information of a device event from the display.

In the apparatus, the microprocessor may be configured to instruct the display to display the historical information at a time when a device event is not detected.

In the apparatus, the microprocessor may be configured to receive instructions from an operator of the wireless communication device to selectively remove historical information of a device event from the display and provide instructions to the display to selectively remove the historical information of a device event from the display

In the apparatus, the microprocessor may be configured to determine usage of the wireless communication device associated with a plurality of predetermined types of device events, to determine the type of device event of the detected device event, and if, during a detected device event, the usage of the wireless communication device is close to exceeding a predetermined amount of available usage of the wireless device for the type of device event of the detected device event, to provide an alarm to the operator indicating that the usage of the wireless device for the type of device event of the detected device event is close to exceeding the predetermined amount of available usage.

In the apparatus, the alarm may be at least one of an audio alarm, a visual alarm and a voice alarm.

In the apparatus, the microprocessor may be configured to continuously count down units indicating remaining usage available for the type of device event of the detected device event during the occurrence of the detected device event and to provide a first alarm to the operator of the wireless communication device when the remaining usage available for the type of device event of the detected event is less than or equal to a first threshold.

In the apparatus, the microprocessor may be configured to provide a second alarm to the operator of the wireless communication device when the remaining usage available for the type of device event of the detected event is less than or equal to a second threshold, the second threshold being less than the first threshold.

In the apparatus, the microprocessor may be configured to prompt the operator to call a service provider to request additional available usage of the wireless communication device for the type of device event of the device event when the usage of the wireless communication device is close to exceeding a predetermined amount of available usage of the wireless communication device for type of device event of the detected device event.

In the apparatus, the plurality of predetermined types of device events may include at least one of: a voice event, a data event, a gaming event, an Internet event, and an operator selected internal activity event.

In the apparatus, a voice event may include an audio communication during at least one of predefined periods of: peak minutes, off peak minutes, weekday minutes, daytime minutes, anytime minutes, evening minutes, nighttime minutes, mobile to mobile minutes, rollover minutes, shared minutes, local minutes, long distance minutes, and roaming minutes.

In the apparatus, the microprocessor may be configured to detect and monitor voice events during at least one period of the predefined periods and to provide historical information indicative of the usage of the wireless communication device for the at least one period.

In the apparatus an operator selected internal activity may include at least one of remaining battery charge and music played by the wireless communication device, and at least one of minutes of remaining battery charge and music played are displayed on the display.

A method of monitoring usage of a wireless communication device may comprise the steps of: detecting a device event of the wireless communication device; monitoring the available usage of the wireless communication device during the occurrence of the detected device event; and continuously displaying the available usage of the wireless communication device during the occurrence of the device event and after the termination of the device event.

The method may further comprise the steps of: providing historical information indicative of the usage of the wireless communication device associated with a plurality of predetermined types of device events and displaying the historical information of at least one type of device event of the plurality of predetermined types of device events.

In the method, the historical information may be displayed at a time when a device event is not detected.

The method may further comprise the step of selectively removing historical information of a device event from the display.

The method may further comprise the steps of: determining the type of device event of the detected device event from among a plurality of predetermined types of device events; determining if, during a detected device event, the usage of the wireless device is close to exceeding a predetermined amount of available usage of the wireless device for the type of device event of the detected device event; and providing an alarm to the operator indicating that the usage of the wireless device for the detected device event is close to exceeding the predetermined amount of available usage for the type of device event of the detected device event.

The method may further comprise continuously counting down the remaining usage available for the type of device event of the detected device event during the occurrence of the device event, and providing a first alarm to the operator of the wireless communication device when the remaining usage available for the type of device event of the detected event is less than or equal to a first threshold.

The method may further comprise the step of providing a second alarm to the operator of the wireless communication device when the remaining usage available for the type of device event of the detected event is less than or equal to a second threshold, the second threshold being less than the first threshold.

The method may further comprise the step of prompting the operator to call a service provider to request additional available usage of the wireless communication device for the types of device event of the detected device event when the usage of the wireless device is close to exceeding a predetermined amount of available usage of the wireless device for the type of device event of the detected device event.

In the method, the plurality of predetermined types of device events may include at least one of: a voice event, a data event, a gaming event, an Internet event, and an operator selected internal activity event.

In the method, wherein a voice event may include an audio communication during at least one of predefined periods of: peak minutes, off peak minutes, weekday minutes, daytime minutes, anytime minutes, evening minutes, nighttime minutes, mobile to mobile minutes, rollover minutes, shared minutes, local minutes, long distance minutes, and roaming minutes.

The method may further comprise the step of detecting and monitoring at least one period of the predefined periods, and providing historical information of the usage of each type of voice event.

In the method an operator selected internal activity may include at least one of remaining battery charge and music played by the wireless communication device, and at least one of minutes of remaining battery charge and music played are displayed on the display.

A computer readable medium may contain a program capable of causing a computer to perform a method of monitoring usage of a wireless communication device comprising the steps of: detecting a device event of the wireless communication device; monitoring the available usage of the wireless communication device during the occurrence of the detected device event; and continuously displaying the available usage of the wireless communication device during the occurrence of the device event and after the termination of the device event.

In the computer readable medium, the method may further comprises the steps of: providing historical information indicative of the usage of the wireless communication device associated with a plurality of predetermined types of device events and displaying the historical information of at least one type of device event of the plurality of predetermined types of device events.

In the computer readable medium, the method may further comprises the steps of: determining the type of device event of the detected device event from among a plurality of predetermined types of device events; determining if, during a detected device event, the usage of the wireless device is close to exceeding a predetermined amount of available usage of the wireless device for the type of device event of the detected device event; and providing an alarm to the operator indicating that the usage of the wireless device for the detected device event is close to exceeding the predetermined amount of available usage for the type of device event of the detected device event.

In the computer readable medium, the method may further comprises the steps of: continuously counting down the remaining usage available for the type of device event of the detected device event during the occurrence of the device event, and providing a first alarm to the operator of the wireless communication device when the remaining usage available for the type of device event of the detected event is less than or equal to a first threshold.

In the computer readable medium, the method may comprise the step of providing a second alarm to the operator of the wireless communication device when the remaining usage available for the type of device event of the detected event is less than or equal to a second threshold, the second threshold being less than the first threshold.

In the computer readable medium, the method may comprise the steps of prompting the operator to call a service provider to request additional available usage of the wireless communication device for the types of device event of the detected device event when the usage of the wireless device is close to exceeding a predetermined amount of available usage of the wireless device for the type of device event of the detected device event.

In the computer readable medium, the plurality of predetermined types of device events may include at least one of: a voice event, a data event, a gaming event, an Internet event, and an operator selected internal activity event.

In the computer readable medium, a voice event may include an audio communication during at least one of predefined periods of: peak minutes, off peak minutes, weekday minutes, daytime minutes, anytime minutes, evening minutes, nighttime minutes, mobile to mobile minutes, rollover minutes, shared minutes, local minutes, long distance minutes, and roaming minutes.

In the computer readable medium, the method may comprise the step of detecting and monitoring at least one period of the predefined periods, and providing historical information of the usage of each type of voice event.

### BRIEF DESCRIPTION OF THE DRAWINGS

The accompanying drawings, which are incorporated in and form a part of the specification, together with the description serve to explain the principles of the invention. In the drawings:

FIG. 1 is a fragmentary front view of a first embodiment which includes a self contained cover device including a battery operated programmable liquid crystal display (LCD), the device being attachable to the outside of an existing mobile phone;

FIG. 2 is a side view of the device taken along line 2-2 of FIG. 1;

FIG. 3 is a view similar to FIG. 2 illustrating the way in which the device is attached to the mobile phone;

FIG. 4 is a rear view of the device taken along line 4-4 of FIG. 2;

FIG. 5 is a schematic illustration of a flexible diaphragm switch which is part of the device of FIG. 1 and which covers the “send/talk” and “end” keys of the mobile phone;

FIGS. 6A through 6F illustrate a second embodiment, in which a new talk time management (TTM) keypad and TTM faceplate are substituted for the original keypad and original, faceplate on an original conventional phone to monitor the time usage of the phone without interfering with the functions which were originally programmed into the phone;

FIG. 7 schematically illustrates the switches provided in association with the “send/talk” or “end” keys of the new TTM keypad and the flat wire assembly leading from those switches to a battery operated programmable LCD timer and display on the TTM faceplate;

FIG. 8 illustrates a third embodiment, in which a conventional mobile phone is provided with specific software designed to selectively override the software programmed originally into the existing mobile phone so that talk time information may be made available to the subscriber;

FIG. 9 schematically illustrates a system for programming the new TTM software into the phone illustrated in FIG. 8;

FIG. 10 is a bottom view taken along line 10-10 of FIG. 8 illustrating the data ports normally provided on mobile phones which can be utilized to receive the programming information in the system of FIG. 9.

FIG. 11 illustrates an exemplary architecture of a wireless phone.

FIG. 12 illustrates an exemplary architecture of a PDA device.

FIG. 13 illustrates an operational flow of an exemplary method of monitoring the activity of a wireless phone illustrated in FIG. 11 or PDA illustrated in FIG. 12.

FIGS. 14A-E illustrate methods for monitoring the various device events in the method of FIG. 13.

FIGS. 15A-C illustrate mechanisms for detecting a device event in accordance with the method of FIG. 13.

FIG. 16 illustrates an exemplary architecture for providing a program for implementing the method of FIG. 13 to a wireless phone or PDA.

FIG. 17 illustrates an exemplary method for providing a program for implementing the method of FIG. 13 to a wireless phone or PDA.

FIG. 18 illustrates various data fields for which an operator may provide information in customizing a program for implementing the method of FIG. 13.

### DETAILED DESCRIPTION OF THE INVENTION

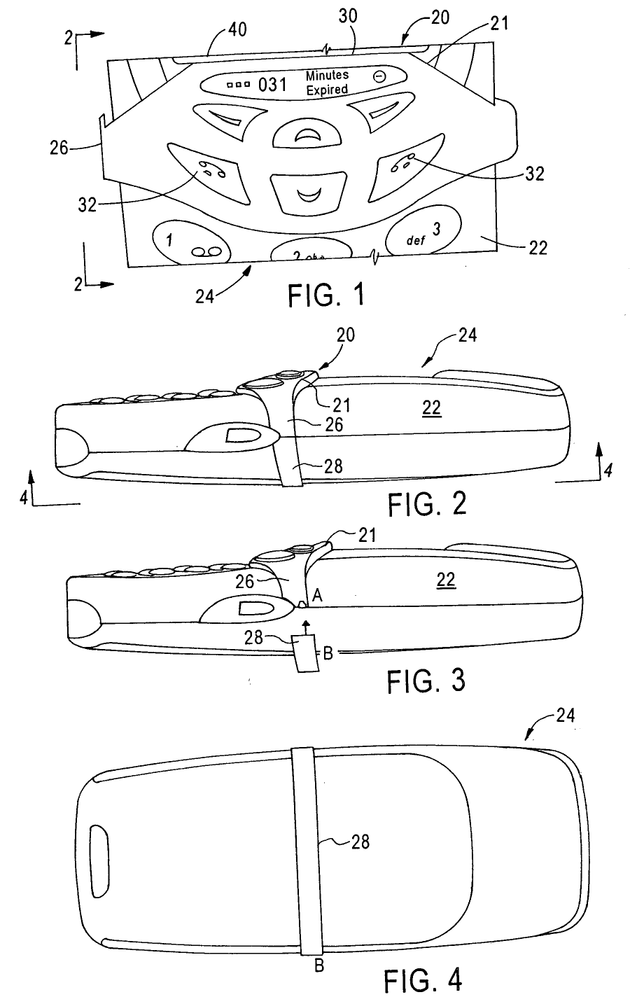

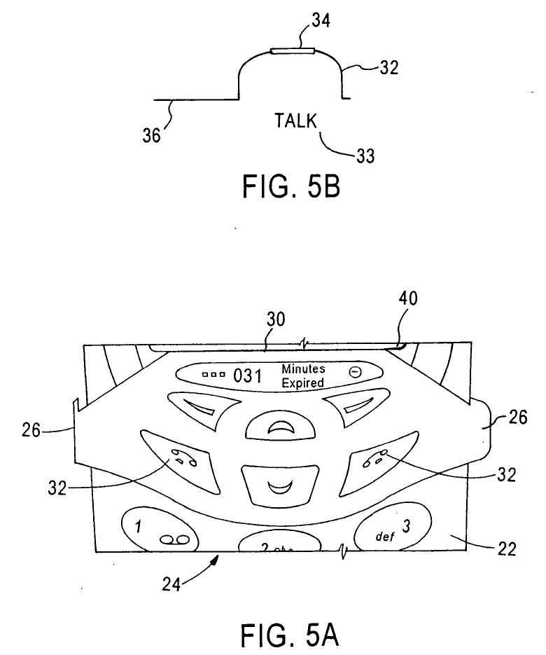

Referring now to FIGS. 1-5 a first example includes a talk time managing (TTM) device 20 formed by a molded plastic cover 21 which mounts on the front faceplate 22 of a conventional standard cell phone 24. The cover 22 has side arms 26 which snap together with a strap 28, which passes around the body of phone 24 to hold cover 21 in place on-the phone.

Mounted within cover 21 is a battery operated, programmable liquid crystal display (LCD) 30 which has a pre-programmed microprocessor to monitor and display time usage information such as programmable minutes, child usage minutes, billing period information (date, month, year) minutes total, minutes remaining, minutes overage alarm, notify the consumer of set program usage through selected tones or alarms, time/LCD clock (date, month and year) and any other time usage information. A soft flexible diaphragm button 32 is mounted on cover 21 and overlies each of the “send/talk” and “end” keys 33 on the keypad of the cell phone and protruding through faceplate 22. Each of the buttons 32 includes a membrane switch 34 connected by way of a flat wire 36 to LCD 30 so as to activate or de-activate the LCD timer 30 when the “send/talk” and/or “end” keys are depressed to initiate or end the conversation using the phone.

The self-contained manually operated TTM 20 is simple in construction, inexpensive, reliable, and quickly installed on the phone, and it does not interfere with the existing functions or information displayed on the LCD 40 which is normally part of the cell phone 24.

As a result, the TTM device 20 can be sold as an after market product and then readily attached to a standard cell phone 24 to provide a subscriber with valuable time usage information so that the subscriber can avoid exceeding the times allotted by his basic billing plan and thereby avoid having to pay excessive over usage charges under that billing plan. The only cost incurred by a subscriber is the original purchase price of device 20. There is no charge for the continued use of the device.

As already mentioned attachment of TTM device 20 onto the outside of faceplate 22 does not interfere with or block the usage of any of the functions or features which are normally provided on a standard cell phone 24.

Each time the soft diaphragm button 32 and the normal send/talk button 33 are depressed to activate the phone LCD the time clock is activated to record the total talk time in minutes used until the end key is activated and the call is terminated. The total talk time is continually added each time the talk and end keys are pushed, thus giving a running total of talk time minutes used. The LCD display 30 is programmed to provide not only the total talk time used but also to inform the subscriber of other desirable information such as the programmable minutes, the billing information, minutes available minutes used, minutes remaining and to signal an alarm to notify the subscriber when the total minutes available under the billing plan have been exceeded.

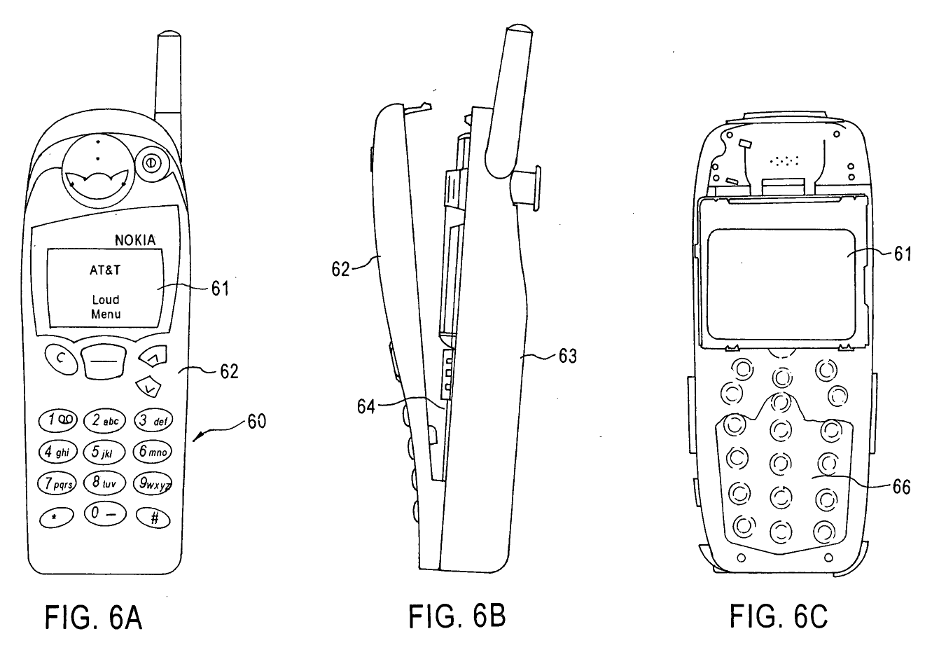

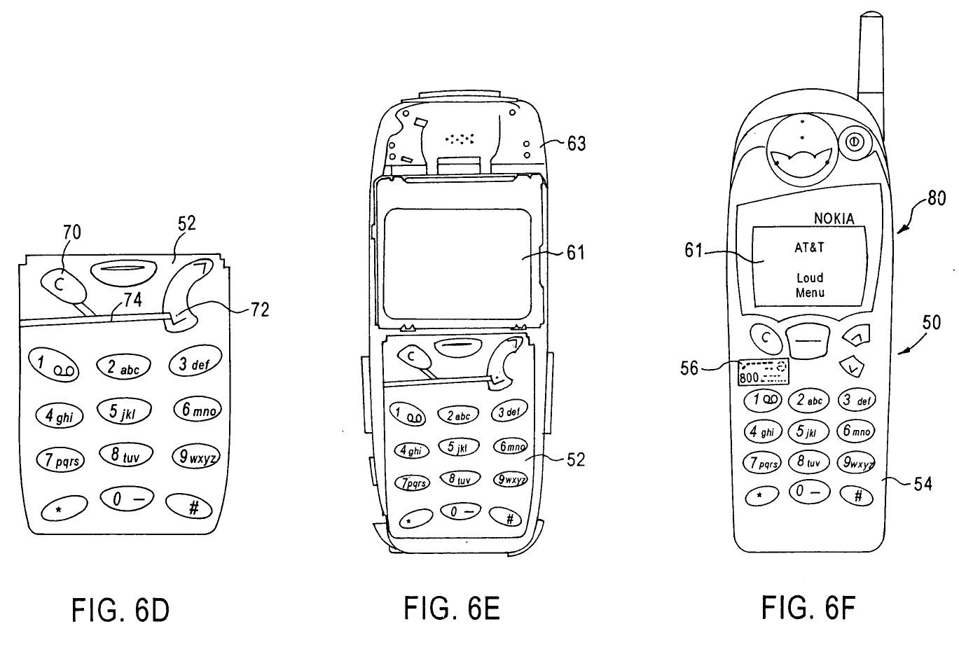

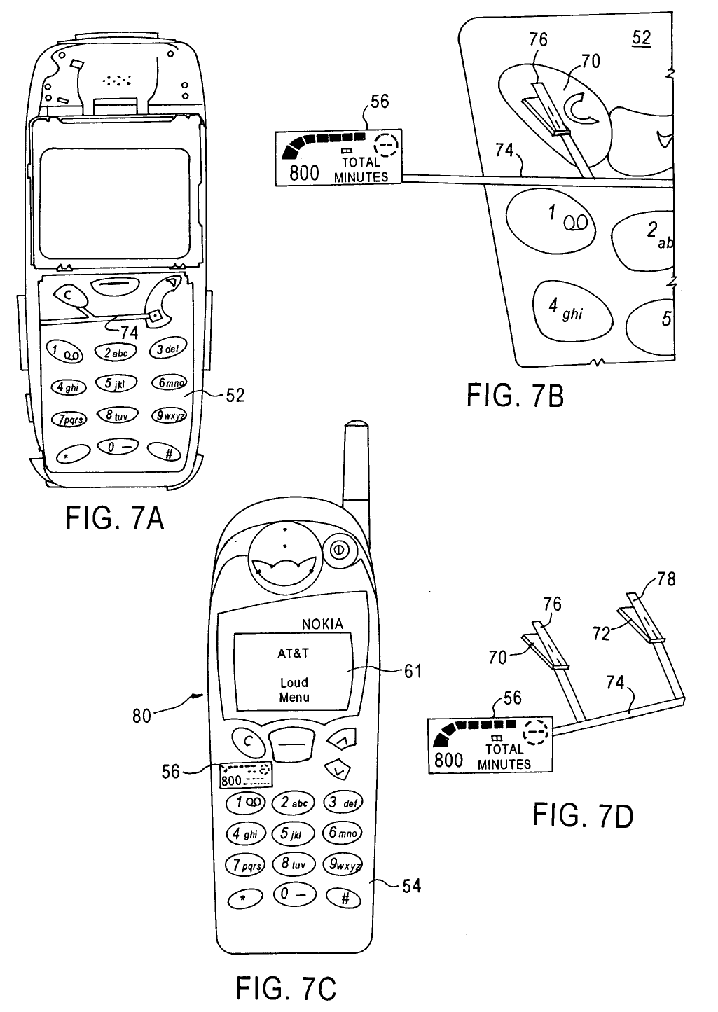

Referring now to FIGS. 6A through 6F and FIG. 7, a second example includes a talk time manager assembly 50 having a novel TTM keypad 52 (FIG. 6D) and a novel TTM faceplate 54 (FIG. 6F) which has a programmable LCD display 56 mounted within.

Keypad 52 and faceplate 54 are constructed so as to fit a particular conventional phone, for example the Nokia phone 60 illustrated in FIG. 6A. To do this, the conventional faceplate 62 and keypad 64 are removed from base 63 of phone 60 as illustrated in FIGS. 6B and 6C. The rest of the phone remains intact within base 63 including the original display 61 and operating circuitry 66 shown in FIG. 6C, so that the various functions and features offered with the original phone 60 are not disturbed.

The faceplate 54 is identical to the original faceplate 64 except for the LCD display 56 mounted within faceplate 54.

The TTM keypad 52 of FIG. 6D may be identical to the original keypad 64 provided in phone 60 except that the send key 70 and end key 72 have associated therewith switches 76 and 78 which will be connected to the LCD display 56 of the TTM faceplate 54 by way of the flat wire assembly 74 mounted directly on TTM keypad 52 when keypad 52 and faceplate 54 are assembled on base 63.

Once the original faceplate 62 and keypad 64 are removed, TTM keypad 52 is mounted in base 63 as shown in FIG. 6E in place of the original keypad. Finally as shown in FIG. 6F. TTM faceplate 54 is snapped into place on base 63. As shown in FIG. 7, with TTM keypad 52 and TTM faceplate 54 assembled on the base 63, the LCD timer 56 on faceplate 54 is connected via flat wire assembly 74 to micro switches 76 and 78 mounted on send and end keys 70 and 72, respectively.

Consequently when the send key 70 is pushed down to initiate usage of the phone, switch 76 is also closed to activate the LCD timer 56 which continues to run until the end key 72 and end switch 78 are pushed down. The LCD display 56 adds up the total time minutes used for all conversations and, as in the embodiment of FIG. 1, provides talk time information to the subscriber as described herein above to avoid over usage and unexpected high billings for the particular billing period.

As with the TTM device 20 of the first example, the components 52 and 54 of assembly 50 are quickly and easily assembled on the body of a conventional phone once the original faceplate and keypad are removed therefrom. Assembly 50 then provides a talk time management function without disturbing the features and functions of the phone originally programmed into the original circuitry 66 when the phone was manufactured. Thus, the time management information displayed to a subscriber by LCD 56 is totally separate from and supplements the information displayed on the original display 61.

Thus, the TTM assembly 50 is installed on the body 63 of an original phone 60 to provide a manually operated, enhanced phone 80 which not only provides all of the functions of the original phone 60 but also affords the subscriber with the talk time information accumulated and displayed by LCD 56. Assembly 50 is manually operated in conjunction with the normal manual operation of the send and end keys of the cell phone and it is inexpensive, reliable, quickly installed and it does not interfere with the normal operation of the phone. It is however invaluable to a subscriber in that it enables the subscriber to keep track of the total time used and/or remaining under his billing plan and thus enables him to avoid additional expensive billing due to over usage. Again, the only cost borne by the subscriber is the initial cost of the purchase of assembly 50, and there are no additional costs for their continued use.

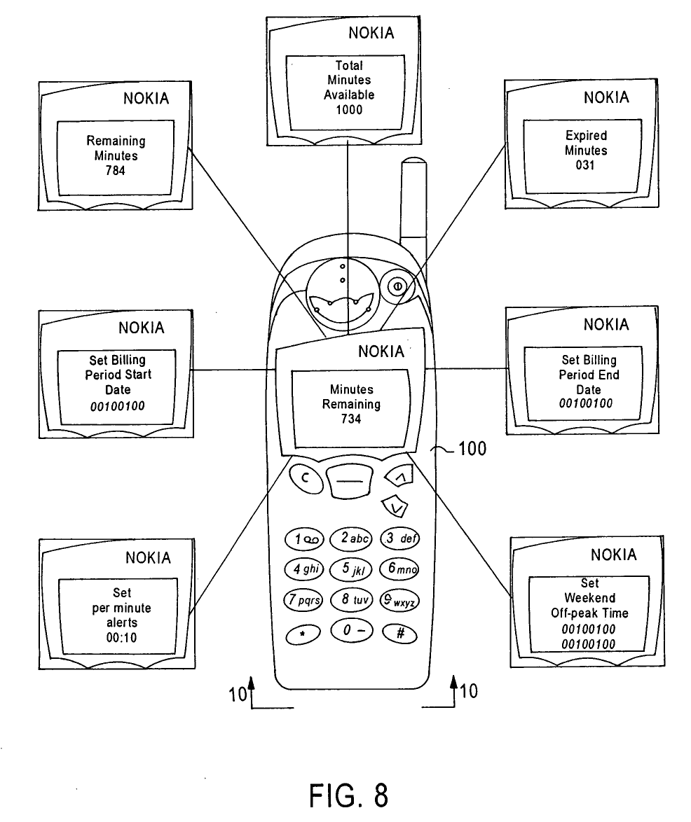

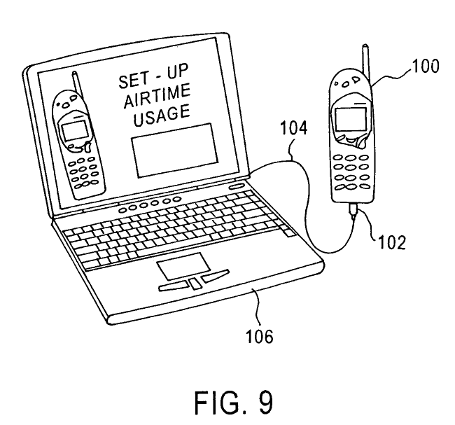

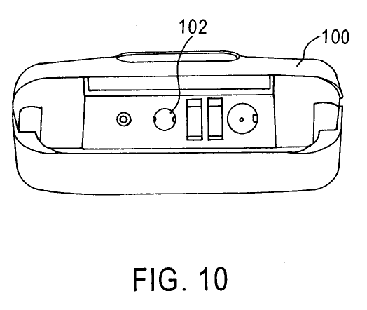

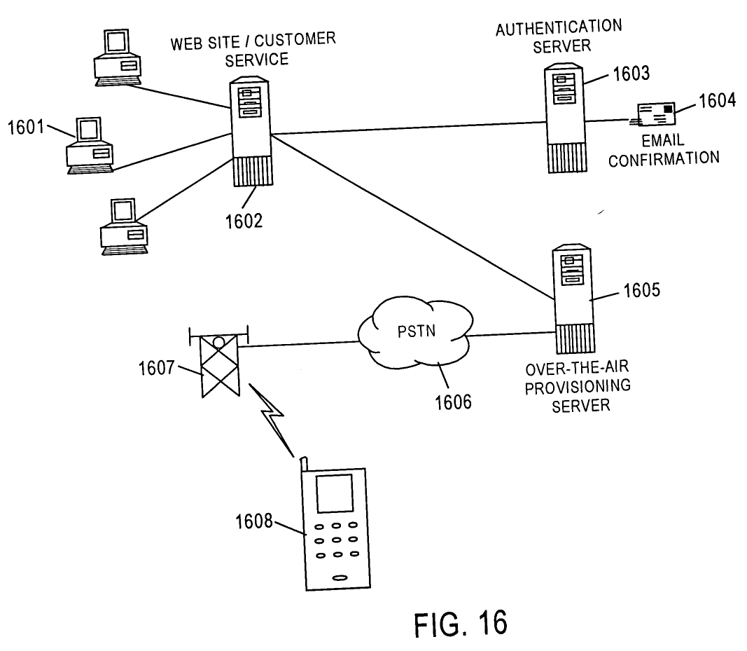

Referring now to FIGS. 8 through 18, a third example includes specific talk time and management software, which is programmed directly into a conventional cell phone 100, to provide the various time management information. FIG. 8 illustrates exemplary screen shots of cellular phone 100 having of management information displayed. The program may be installed by way of a system illustrated in FIG. 9 which includes the cell phone 100 which has at least one data port 102 connected by way or a cable 104 to a computer 106, which is loaded with the select program that is to be installed in the cell phone 100. FIG. 10 shows data port(s) 102 located on the bottom surface of cellular phone 100. Alternatively, the program may be installed by a wireless system employing for example, cellular towers and/or satellites as described in connection with FIG. 16.

As with the previous examples, cell phone 100 may be programmed to selectively display or hide the billing period, minutes available, minutes used, minutes remaining and to signal an alarm to notify the consumer the set usage or program usage.

Those of skill in the art will appreciate that the concepts disclosed herein may apply to any time usage devices, such as a wireless telephone and PDA devices.

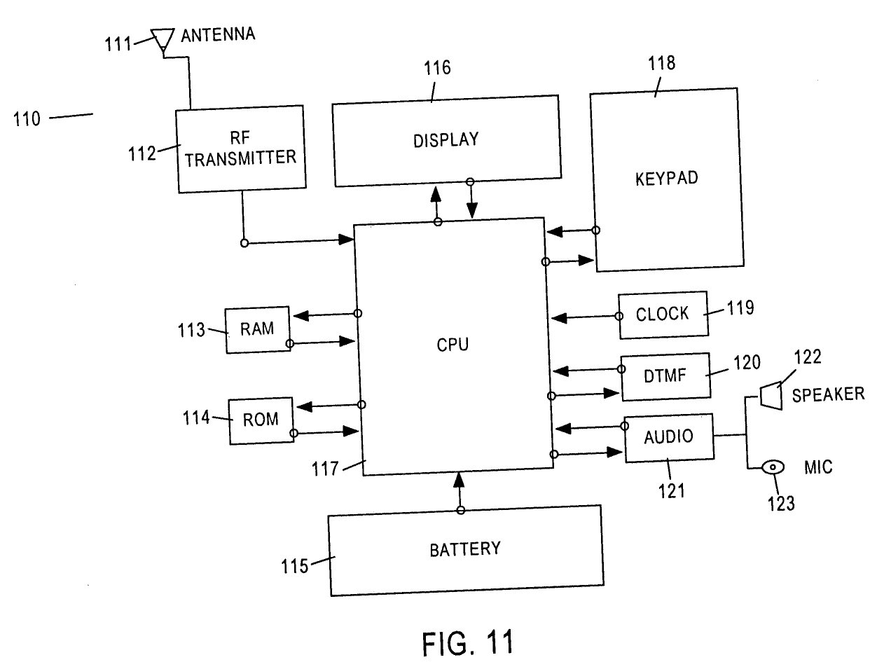

FIG. 11 illustrates an exemplary schematic of a wireless phone 110 that may be used. As illustrated in FIG. 11, a microphone 123 may receive sound (voice) from an operator and provide the sound as an analog signal to an audio unit 121, such as a VOCODER, which processes the sound signal and may provide the processed information as digitized audio data to a CPU 117. The voice data, formed by digitizing the audio signal, may contain a spoken command information which causes the CPU 117 to perform various functions, such as dialing a call, and displaying information such phone numbers on display 116. The CPU 117 accesses ROM 113 and RAM 114 to retrieve program information and data to perform various functions such as, dialing a call and retrieving numbers from a phone book. The voice data does not contain command information, the digitized audio data may pass through (or bypass) CPU 117 to RF transmitter/receiver (transceiver) 112, for example, once a call is established through the wireless network.

Clock 119 preferably provides clocking data to the CPU which may be used by the CPU 117 to monitor and display the time of day, the time a call is initiated and/or ended, and the duration of the call. Key pad 118 may be used by an operator to input commands to CPU 117 to perform various functions, such as placing a phone call, storing phone numbers in a phone book, and settings various parameters for control functions within the CPU 117. DTMF (dual tone multiple frequency) unit 120 provides frequencies and tones to CPU 117. RF transmitter/receiver 112 may be in the form of one or more digital transceivers which transmit and receive data through antenna 111. The transmitted data may include any form of data, such as voice data formed by digitizing the audio signal received from microphone 123 and operational data that may be used to control various functions of the CPU 117. The received data may also include any form of data, such as voice data from another telephone and operational data that may be used to control various functions of the CPU 117. Audio unit 121 and speaker 122 may convert received voice data to audio output that may be heard by an operator. Battery 115 may be provided to supply electrical power to the circuitry of the wireless phone.

Operational data may also be provided to CPU 117 through data port 102 (FIG. 10), as well as through key pad 118, RF transmitter/receiver unit 112 and/or microphone 123. Display 116 may also be in the form of a touch screen display which may enable an operator to provide operational data to CPU 117 by pressing the screen.

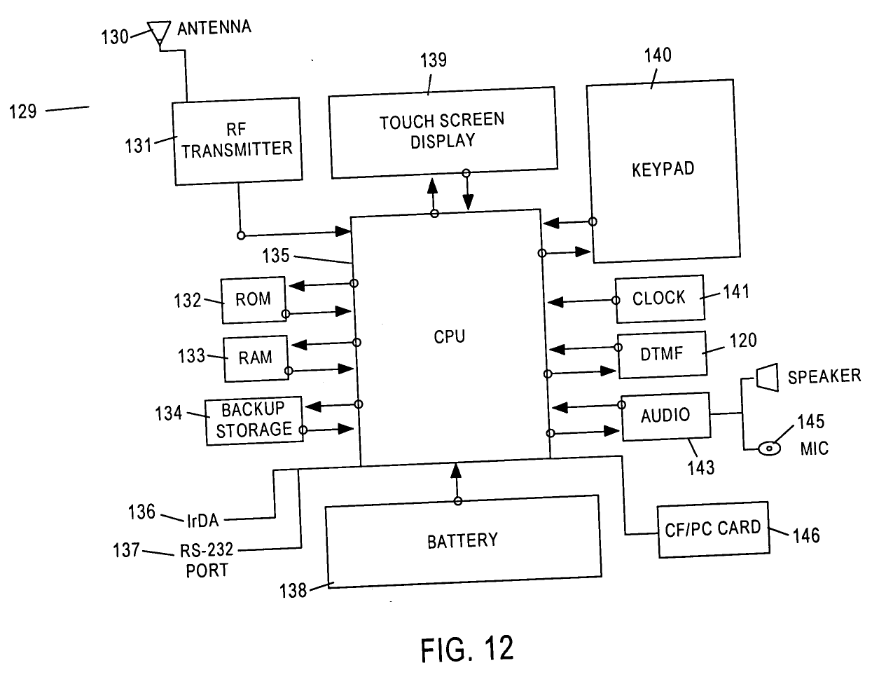

FIG. 12 illustrates an exemplary architecture of a PDA/phone hybrid handset 129 that may be used. As illustrated in FIG. 12, an operator may provide input through keypad 140 to microprocessor 135. Backup storage 134, ROM 23 and RAM 25 may store operational information and user information. A touch screen display 139 may display information to the user and allow the user to provide input to CPU 135. Clock 141 preferably provides clocking data to the CPU which may be used by the CPU 135 to monitor and display the time of day, the time a session is initiated and/or ended, and the duration of the a session. Key pad 140 may be used by an operator to input commands to CPU 135 to perform various functions, such as placing a phone call, storing phone numbers in a phone book, and settings various parameters for control functions within the CPU 135. DTMF (dual tone multiple frequency) unit 142 provides the necessary frequency and tones to CPU 117 to allow a communication. RF transmitter/receiver (transceiver) 131 may be in the form of one or more digital transceiver(s) which provide wireless communication through antenna 130. The transmitted data may include any form of data, such as voice data received from microphone 123 and operational data that may be used to control various functions of the CPU 117. The received data may also include any form of data, such as voice data from another telephone and operational data that may be used to control various functions of the CPU 117. Audio unit 121 and speaker 122 may convert received voice data to audio output that may be heard by an operator. Battery 115 may be provided to supply electrical power to the wireless phone.

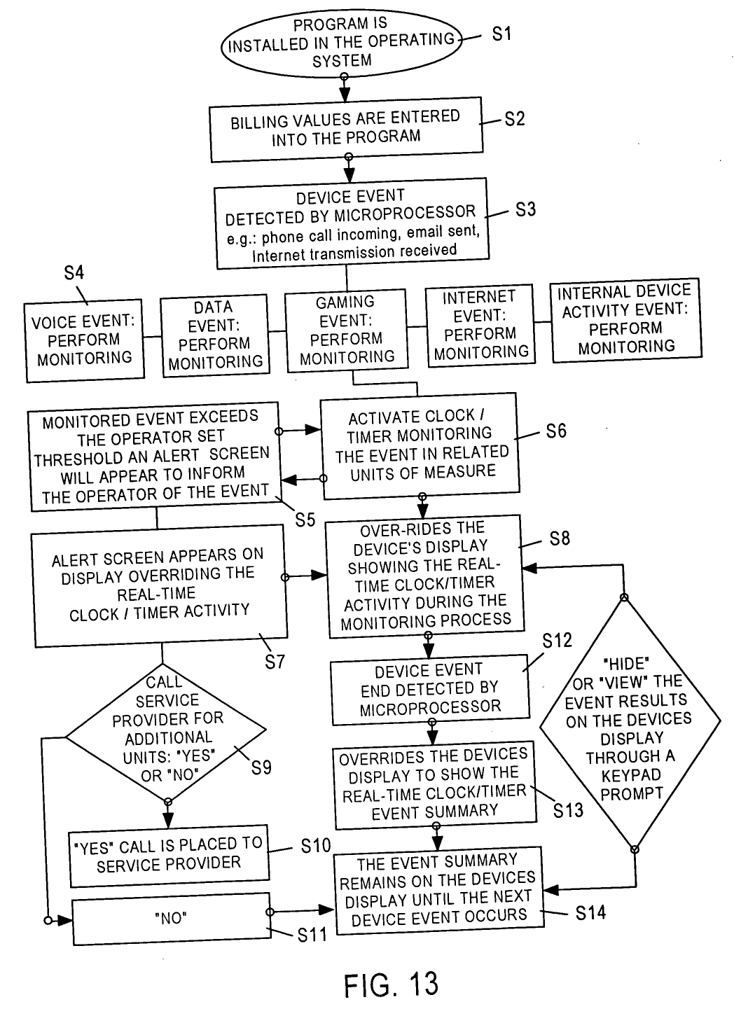

FIG. 13 illustrates an operational flow of monitoring a mobile communication device air time usage as may be implemented by either CPU 117 in an exemplary wireless phone illustrated in FIG. 11 or CPU 135 in an exemplary PDA device illustrated in FIG. 12. As illustrated in FIG. 13, the software program is preferably installed in wireless phone 110 or PDA 129 in step S1. Once the software program is installed, billing values are entered as illustrated in step S2. The billing values preferably include the billing plan with the service provider, such as billing periods, start and stop dates of a billing cycle; categories of billing rates, e.g. peak, off peak, weekday minutes, daytime minutes, anytime minutes, evening minutes, nighttime minutes, mobile to mobile minutes, rollover minutes, shared minutes, local/long distance and roaming minutes, etc, and the associated billing rates and billing times for each of the categories of billing rates. In the preferred embodiment, the billing values used by the program are updated periodically, such as by automatically resetting the billing parameters (e.g. minutes available) at the beginning of a billing period or at any other time desired by the user. The CPU 117 also carries forward any unused voice or data usage (e.g. minutes) from a previous billing period if the user's billing plan provides for roll-over of the unused minutes. In operation, the CPU 117 or 135, detects an event which initiates monitoring of the minutes, as illustrated in step S3. As illustrated in step S4, the event may include: a voice event, such as placement or receipt of a phone call; a data event, such as a SMS (text) message of data sent or received; a gaming event, such as the initiation of a game over a wireless network; an Internet event, such as logging on to a sever via the Internet; and/or any other internal device activity that the operator may designate as a device event for air-time monitoring.

CPU 117 and 135 preferably discriminate the type of communication being received or sent. Those of skill in the art will appreciate that voice calls, as well as internet calls, data calls, GPRS calls and SMS messages and calls of different types can all have different settings associated, using the relevant “bearer code”. CPU 117 and 135 preferably recognizes the bearer code and or radio frequency associated w/the incoming or outgoing call and activates the corresponding timer to monitor that event and record the event activity. CPU 117 and 135 also preferably keep a log of all incoming and outgoing communications. The log may be stored on an internal memory of CPU 117 and 135 or on 113 and 133, respectively, or any other memory device.

Once a device event is detected, the duration or quantity of the event is monitored, as illustrated in step S6 of FIG. 13. In the air-time minutes example, a countdown timer programmed within CPU 117 and 135 is activated which counts down the remaining minutes in the billing plan according to the device event and the billing plan. In the case of a data device event, a byte counter programmed within CPU 117 and 135 may be used to count down available bytes remaining under a billing plan or to count up bytes transferred. Those of skill in the art will also appreciate that a single device event may be monitored by both the duration of the event and the quantity of the event, such as by initiating both the timer and the byte counter.

As illustrated in step S8 of FIG. 13, in the preferred embodiment, the CPU 117 or 135 overrides the display to display the real time monitoring of the device event, such as displaying the minutes remaining under the billing plan as they are counted down by the timer. When a device event ends, as illustrated by step S12, the real-time event summary is preferably displayed, which preferably informs the operator of the duration or quantity of the device event, e.g. the length of a phone call, and of the minutes used. As shown in step S14, the event summary remains displayed until the next device event occurs. The event summary may be removed from the display by the operator by providing an instruction to hide the event summary such as through a key prompt, as illustrated in step S15. The event summary may be returned to the display by the operator providing an instruction such as through a key prompt also. Those of skill in the art will appreciate that the instruction to hide and view the event summary may be provided to the CPU 117 and 135 by other mechanisms, such as a voice prompt.

The CPU 117 or 135 may also calculate daily, weekly and monthly averages of minutes or kilobytes used in each category and display the calculated averages. The CPU 117 and 135 may also determine and display the number of days remaining in a billing cycle and display an average number of minutes or kilobytes that can be used each remaining day or week of the billing cycle for each category of minutes or kilobytes. The CPU 117 or 135 may display several categories of minutes at the same time, such as the remaining peak minutes, off peak minutes and mobile to mobile minutes. Displays may be textual or graphic or both.

If the device event exceeds a threshold of activity, such as less than 20 minutes remaining in the billing plan, the wireless phone 110 or PDA 129 preferably provides an alert to the operator, as illustrated in step S5. In the preferred embodiment, a plurality of thresholds may be set by the operator in seconds, minutes, days, weeks, month's etc, to keep the operator apprised of the usage of the voice and data usage. The alert may be in the form of an audio alert and/or in the form a visual alert by a text message, or other indicator, displayed on display 116 or 139. As illustrated in step S7, the alert preferably appears on the display and overrides the displayed real time monitoring information. The operator may be prompted to call the service provider to request additional units (e.g. minutes) in the billing plan, as illustrated by steps S9, S10 and S11.

CPU discriminates if the event being monitored is an event which incurs charges or uses minutes. Events which do not incur charges, such as 911 and 611 calls and calls on billing plans which offer unlimited minutes for data or voice usage, preferably are not subtracted from the available minutes. An event may be any predefined activity of the CPU 117 or 135 which may be initiated and terminated by an internal or external activity of the device and may include a voice event, a data event, a gaming event, and Internet event, and an operator selected internal activity event.

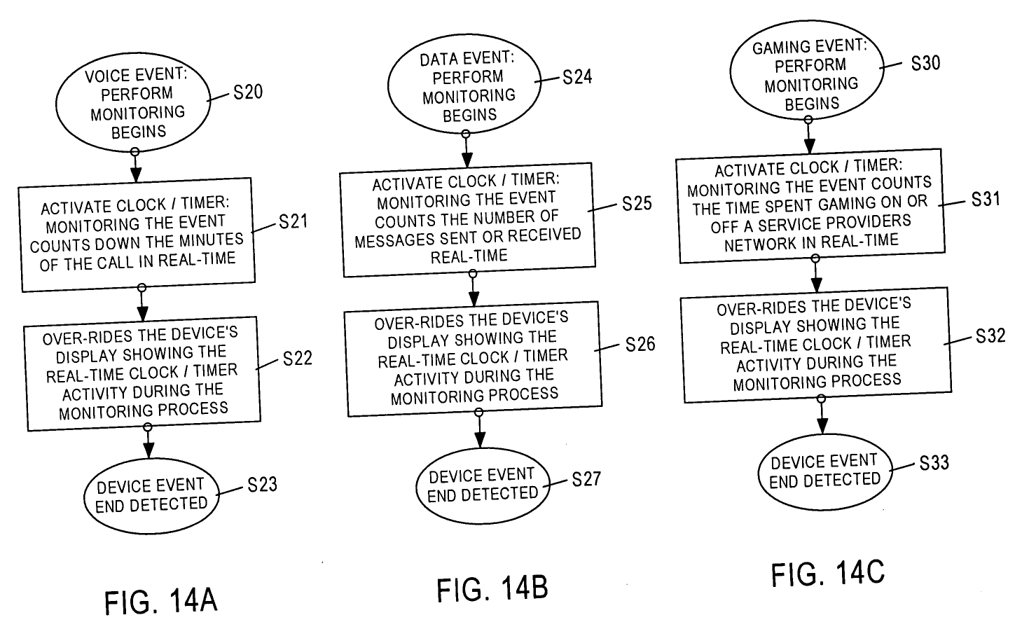

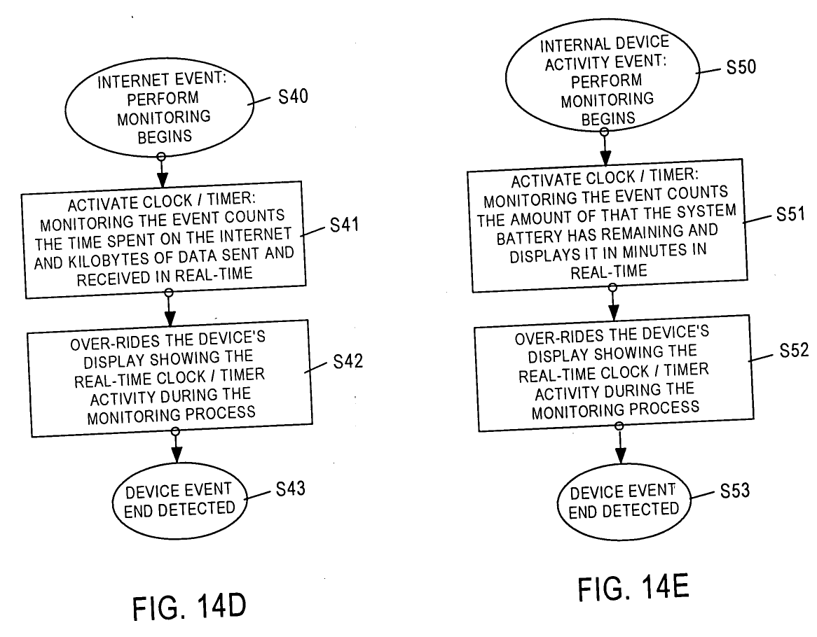

FIGS. 14A-E illustrate the monitoring activity associated with the device events of step S4 in FIG. 13. As illustrated in FIG. 14A, when a voice event is detected (step S20), in this embodiment, a timer is activated to countdown the remaining minutes in the billing plan used during the telephone call, as illustrated in step S21. For example, if a user has 1000 minutes available under a peak billing period, if a voice device event is detected during the peak billing period, the count down timer counts the minutes used by counting down from 1000 minutes, e.g. if 5 minutes are used then the timer counts down to 995 minutes. Those of skill in the art will appreciate that any type of timer may be used, such as a count up timer, which time is then subtracted from the available billing time. The real time countdown of minutes during the monitoring process is preferably displayed during a call, as illustrated in step S22. The timer counts down the minutes until the end of the call is detected, such as by detecting a termination of the connection, as illustrated in step S23.

FIG. 14B illustrates an exemplary monitoring process performed when a data event is detected, as illustrated in step S24. As illustrated in step S25, a data event may be monitored by counting the number of email, multimedia or text messages sent or received in real time from the wireless phone or PDA to another wireless phone or PDA or a computer. The units counted (messages or bytes, etc.) correspond to the units used for billing under the user's particular data service plan. The real time counting activity may be displayed during the data event, as illustrated in step S26. The monitoring process stops when the end of the data event is detected, such as by detecting a termination of the connection with the data source or data receiver, as illustrated in step S27.

FIG. 14C illustrates an exemplary monitoring process performed when a gaming event is detected, as illustrated in step S30. A gaming event may be characterized by connecting to a service provider network. A gaming event may be monitored by counting the number messages sent or received and/or by monitoring the amount of time connected to a network in real time, depending on the applicable billing units, as illustrated in step S31. The real time counting and timer activity may be displayed during the gaming event, as illustrated in step S32. The monitoring process stops when the end of the gaming event is detected, such as by detecting a termination of the connection with the service provider network, as illustrated in step S33.

FIG. 14D illustrates an exemplary monitoring process performed when an Internet event is detected, as illustrated in step S40. An Internet event may be characterized by connecting to one or more of a plurality of servers through website addresses. For example, the mobile station may start counting when the user logs in to an Internet access service. An Internet event may be monitored by the amount of time connected to the Internet and/or counting the number of kilobytes of data sent and received from the Internet, in real time, as illustrated in step S41. The real time counting and timer activity may be displayed during the Internet event, as illustrated in step S42. The monitoring process stops when the end of the data event is detected, such as by detecting a termination of the Internet session with the service provider network, as illustrated in step S43.

FIG. 14E illustrates an exemplary monitoring process performed to monitor internal activity of the wireless phone 110 or PDA 129, as illustrated in step S50. Examples of internal activities which may be monitored may be the remaining power in battery 115 or 138; amount of memory space available in RAM 114 or 133 for downloads; or minutes of music played (MP3) in a given period of time. As illustrated in step S51, the internal activity may be monitored by the counting down the amount of time remaining for the device activity in real time or by counting up the usage, such as minutes of battery remaining and/or music played are displayed, respectively. The real time timer activity may be displayed during the monitoring process, as illustrated in step S52. The monitoring process stops when the end of the internal activity is detected, as illustrated in step S53.

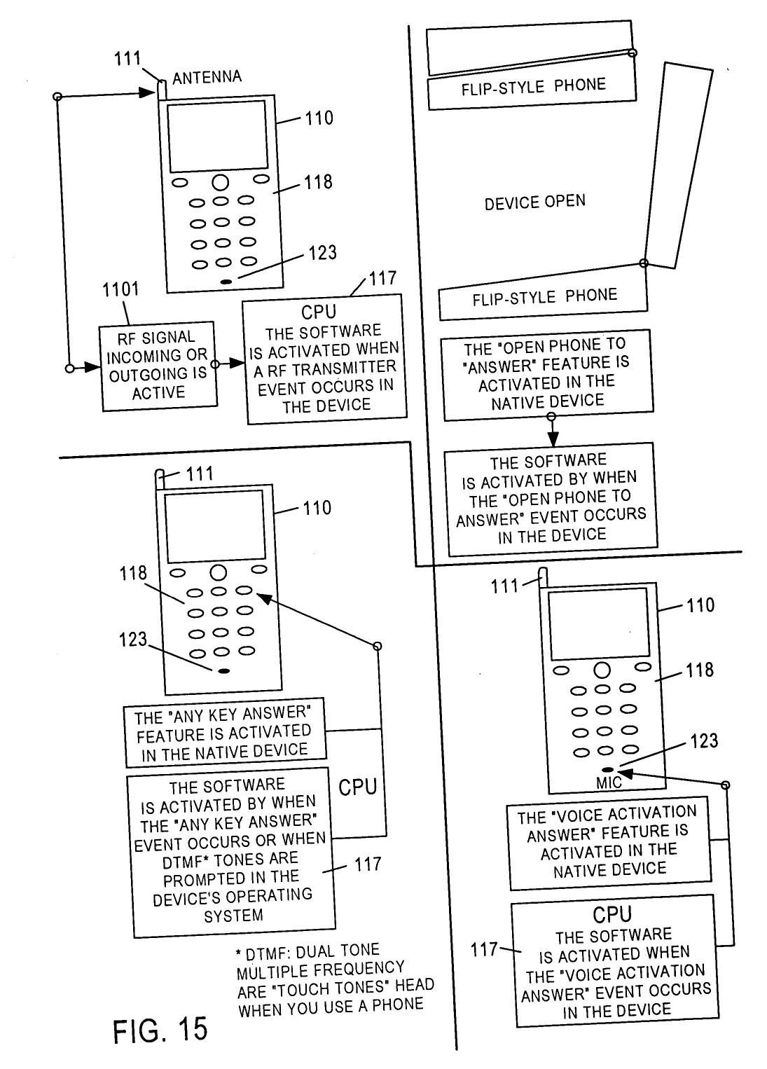

FIGS. 15A-C illustrate exemplary techniques for detecting a device event by an exemplary wireless phone 110. Those of skill in the art will appreciate that the discussion herein applies equally to exemplary PDA device 129. As illustrated in FIG. 15A, a device event may be detected by CPU 117 when RF transmitter/receiver 112 initiates the sending or receiving of a signal 1101. FIG. 15B illustrates CPU 117 detecting a device event by activation of a switch 1102 upon opening of flip type wireless phone 110. FIG. 15C illustrates CPU 117 detecting a device event when any key on key pad 118 is pressed to answer an incoming communication to wireless phone 110 or when DTMF tones are prompted in CPU 117. FIG. 15C illustrates CPU 117 detecting a device event when a voice command is received from microphone 123 to answer or send a communication. Those of skill in the art will appreciate that other mechanisms may be used to detect a connection or communication with a wireless device, for example, the device event may be detected by a motion activated switch which detects a connection or communication with the wireless device.

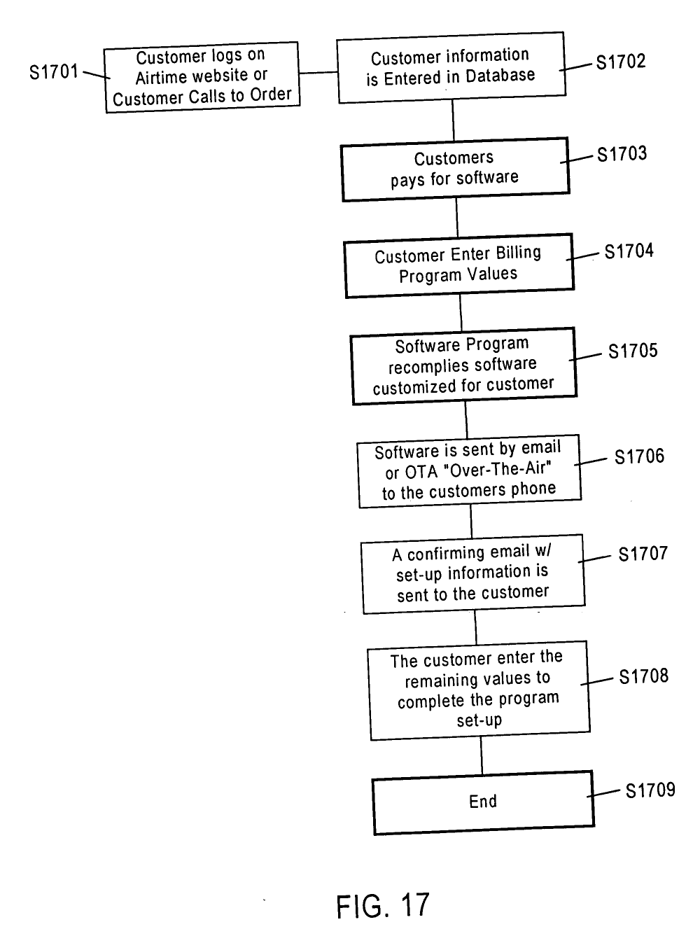

FIGS. 16-18 illustrate an exemplary architecture method for receiving and installing a minute counter program capable of performing the operations illustrated in FIG. 13. As illustrated in FIG. 16 and in step S1701 of FIG. 17, customers preferably use a home computer 1601 to communicate with a server 1602 via a website of a vendor carrying a suitable program to implement the steps of FIG. 13. The customer may also call the vendor using a telephone and speak to a customer service representative. The website or customer service representative of the vendor preferably prompts the customer to enter necessary personal information into a database of the vendor, as illustrated in step S1702. The customer preferably pays for the program by providing appropriate billing information, such as a credit card account, as illustrated in step S1703. An authentication server 1603 may be employed to authenticate the validity of the customer's purchasing information, such as credit card information. The customer may enter their billing plan information of their wireless phone or PDA service provider, as illustrated in step S1704 of FIG. 17. The vendor preferably enters the billing plan information into the program and recompiles the program to be customized to the customer's needs, as illustrated in step S1705. The program may be sent to the customer by email in which case the customer may enter the program in their wireless phone or PDA as illustrated in FIGS. 9 and 10. Alternatively, the vendor may transmit the program to an over the air provisioning (OTA) server 1605 which transmits the program through a PSTN 1606 or public data network, through the cellular network to a cellular phone tower 1607, which wirelessly transmits the program to the wireless phone or PDA 1608 of the customer. As illustrated in step S1707 of FIG. 17, a confirmation email 1604 is preferably sent from the authentication server 1603 to the customer which preferably provides additional set up information necessary for the customer to install and/or activate the program in their wireless phone or PDA. Once the customer enters the remaining setup information (step S1708), the program preferably prompts the CPU in wireless phone or PDA 1608 to install the program and to overwrite conflicting portions of other programs already installed. Once the program is installed in the wireless phone or PDA 1608, the installation process is complete, as illustrated in step S1709. The illustrated servers may be operated by a carrier or a communication service provider, or other parties, for example, the website server and/or the provisioning server may be operated by the manufacture of the mobile communication device or even by a third party software vendor.

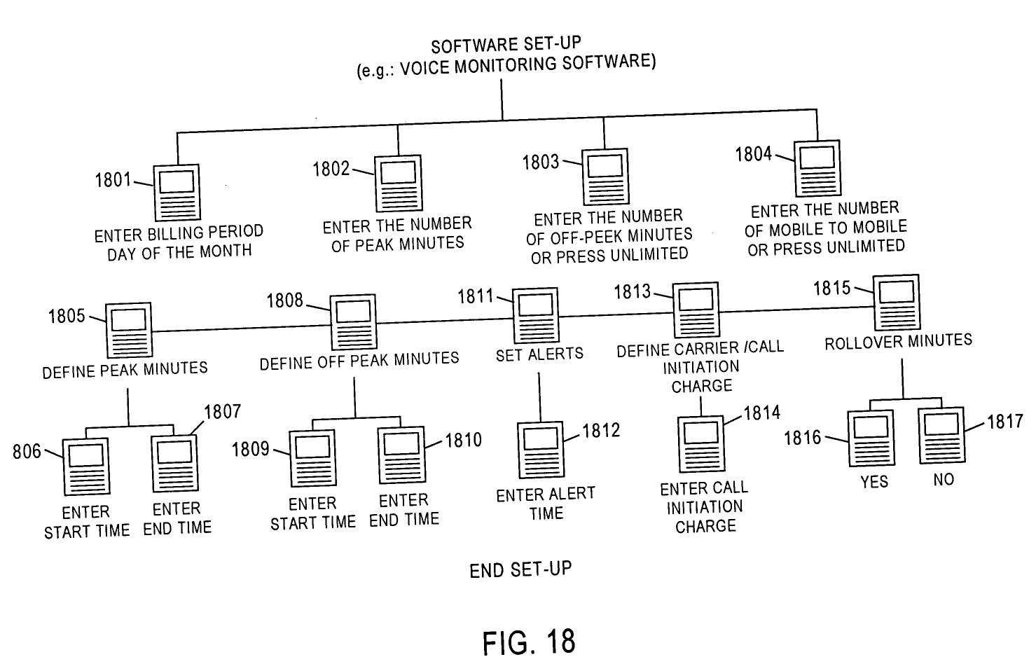

FIG. 18, illustrates various information fields in which the customer may be asked to provide information in entering their billing information. As illustrated in FIG. 18, the customer may be asked to enter the billing period 1801, including the day of the month in which a new period starts; the number of peak minutes 1802 available under the billing plan; the number of off peak minutes available 1803; and the number of mobile to mobile minutes 1804. The customer may also be asked to define peak minutes 1805 by identifying the start time 1806 and end time 1807 of the peak minutes period. Likewise, the customer may be asked to define off peak minutes 1808 by identifying the start time 1809 and end time 1810 of the off peak minutes. The customer may set the type of alert desired 1811 and one or more threshold(s) 1812 of remaining minutes when an alert should be made. The customer may also define their service provider's call initiation charge 1813, if any, and identify the amount of the charge 1814. Carrier initiation charges may include various specific charges from the carrier such as: billing from the time a call connects with the carrier's network; billing for the first minute of the ringing time regardless if a call is answered; billing for the first minute if the call rings for 30 seconds; and billing for the first minute from the first ring. The customer may also specify if rollover minutes 1815 are available under their billing plan by selecting YES 1816 or NO 1817.

The software embodiment can be particularly useful for businesses having a large number of employees who have been provided with cell phones and who normally have very little understanding of control over the time usage of the phone until the bills are received at the end of the billing period. A business may periodically use the computer 106 to check each of the cell phones 100 that are in the field to gain knowledge of the actual usage within a billing period and therefore try to cut down on the actual usage during the remaining period and thereby avoid outrageous bills at the end of the period.

The CPU 117 or 135 may be further programmed to, at a predetermined time (e.g., once a day, week, month, or the end of a billing cycle) automatically send usage information to a computer or another wireless device using, for example, SMS (text) messages or a report file of all activity of the device. The usage information may be sent by a wireless transmission or may be sent through a wire connection to the wireless phone or PDA and the computer or other wireless device. The usage information may include the number of minutes used in each category of minutes, the quantity of data sent or received and/or device activity information for a given period of time, such as a day, week or a month. The wireless phone or PDA may be prompted to send the usage information by receiving a signal from the computer. The SMS messages or report file may preferably be used to display the usage of the wireless phone or PDA by the computer or other wireless device, and may be forwarded to another computer or wireless device by email, saved, or printed by the computer or wireless device. In this manner, a business may monitor the usage of several wireless and PDA devices and plan their budget accordingly.

CPU 117 and 135 may also be programmed to provide an audio message of the remaining minutes or kilobytes in each category. The audio message may be in the form of a computer generated voice which advises the operator of the remaining minutes or kilobytes in each category. The voice message may be integrated with a visual and/or other audio alert. The audio message may occur between the time of the call and the connection to the network; after the call is completed; or during the call which may be based on a prompt by the operator at any time. The voice message may selectively be activated or deactivated by the operator. The audio and voice message provides a method of monitoring data and voice usage as well as internal device activity in real time in a manner convenient and safe to the operator while involved in other tasks, such as driving a vehicle.

The architecture illustrated in the wireless telephone 110 in FIG. 11 and the PDA handset 129 in FIG. 12, may be entirely contained on one circuit board or a single integrated circuit chip and the functions may be performed by programmable software. Moreover, the operations illustrated in FIGS. 13-14 may be performed by programmable software on the ROM 113 or 132 or memory internal to CPU 117 or 135 or any other memory in the wireless telephone or PDA, respectively. The software that performs the operations illustrated in FIGS. 13 and 14 may be embodied in the form of data in a computer readable medium. A computer readable medium within the scope of this disclosure includes any medium, physical or metaphysical, which is capable of carrying information in a form which can be read by an appropriately configured computer or mobile communication device and associated peripheral devices of the computer or station, including, but not limited to: an optical readable/writeable disc, a magnetic disk, a readable/writeable card, a magnetic tape, an electrical transmission signal for wireline or wireless transmission or optical transmission of data using electrical and/or electromagnetic signals. The data associated with the programmable software may be in the form of packetized digital data.

Accordingly, the exemplary embodiments provide a monitoring or talk time managing system that can be readily incorporated into standard cellular phones to provide a variety of time usage information to the subscriber at any time during a normal billing period. The system also enables wireless communication subscribers to monitor usage, programmable minutes, child usage, billing period information, minutes available, minutes used, minutes remaining, and to signal an alarm to notify the consumer approaching over usage. The novel systems operate without disrupting normal phone functions and 911 dialing which are initially programmed into the circuitry of the cell phone when the phone is manufactured.

The examples provide the above novel systems which are manually operated, inexpensive, quickly installed into the phone and reliable in operation, to provide a time usage feature which supplements the various other features programmed originally into the phone. Examples also provide the above novel systems as after market devices which can be readily installed into standard commercial cell phones without interfering with or disrupting normal phone functions. The only cost borne by a subscriber is the initial cost of the purchase of the devices or software, and there are no additional costs for their continued use.

It is apparent that the various embodiments of the invention as described above satisfy the objectives initially set forth herein above and provide cell phone subscribers with time usage systems that help avoid excessive over billing at the end of a billing period.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A wireless communication device comprising:
a transmitter/receiver capable of transmitting and receiving a plurality of data signals;
a microprocessor connected to the transmitter/receiver and configured to detect a device event, and provide monitoring information indicative of the usage of the wireless communication device during the occurrence of the detected device event; and
a display capable of continuously displaying the monitoring information during the device event and after the end of the device event.

2. The wireless communication device of claim 1, wherein the microprocessor is configured to provide historical information indicative of the usage of the wireless communication device associated with a plurality of predetermined types of device events and instruct the display to continuously display the historical information of at least one type of device event of the plurality of predetermined types of device events.

3. The wireless communication device of claim 2, wherein the microprocessor is configured to instruct the display to display the historical information at a time when a device event is not detected.

4. The wireless communication device of claim 2, wherein the microprocessor is configured to receive instructions from an operator of the wireless communication device to selectively remove historical information of a device event from the display and provide instructions to the display to selectively remove the historical information of a device event from the display.

5. The wireless communication device of claim 1, wherein the microprocessor is configured to determine usage of the wireless communication device associated with a plurality of predetermined types of device events, to determine the type of device event of the detected device event, and if, during a detected device event, the usage of the wireless communication device is close to exceeding a predetermined amount of available usage of the wireless device for the type of device event of the detected device event, to provide an alarm to the operator indicating that the usage of the wireless device for the type of device event of the detected device event is close to exceeding the predetermined amount of available usage.

6. The wireless communication device of claim 5, wherein the alarm is at least one of an audio alarm, a visual alarm and a voice alarm.

7. The wireless communication device of claim 5, wherein the microprocessor is configured to continuously count down units indicating remaining usage available for the type of device event of the detected device event during the occurrence of the detected device event and to provide a first alarm to the operator of the wireless communication device when the remaining usage available for the type of device event of the detected event is less than or equal to a first threshold.

8. The wireless communication device of claim 7, wherein the microprocessor is configured to provide a second alarm to the operator of the wireless communication device when the remaining usage available for the type of device event of the detected event is less than or equal to a second threshold, the second threshold being less than the first threshold.

9. The wireless communication device of claim 5, wherein the microprocessor is configured to prompt the operator to call a service provider to request additional available usage of the wireless communication device for the type of device event of the device event when the usage of the wireless communication device is close to exceeding a predetermined amount of available usage of the wireless communication device for type of device event of the detected device event.

10. The wireless communication device of claim 5, wherein the plurality of predetermined types of device events include at least one of: a voice event, a data event, a gaming event, an Internet event, and an operator selected internal activity event.

11. The wireless communication device of claim 10, wherein a voice event includes an audio communication during at least one of predefined periods of: peak minutes, off peak minutes, weekday minutes, daytime minutes, anytime minutes, evening minutes, nighttime minutes, mobile to mobile minutes, rollover minutes, shared minutes, local minutes, long distance minutes, and roaming minutes.

12. The wireless communication device of claim 11, wherein the microprocessor is configured to detect and monitor voice events during at least one period of the predefined periods and to provide historical information indicative of the usage of the wireless communication device for the at least one period.

13. The wireless communication device of claim 10, wherein an operator selected internal activity includes at least one of remaining battery charge and music played by the wireless communication device, and at least one of minutes of remaining battery charge and music played are displayed on the display.

14. A method of monitoring usage of a wireless communication device comprising the steps of:
detecting a device event of the wireless communication device;
monitoring an available usage of the wireless communication device during the occurrence of the detected device event; and
continuously displaying the available usage of the wireless communication device during the occurrence of the device event and after the termination of the device event.

15 The method of claim 14 further comprising the steps of:
providing historical information indicative of the usage of the wireless communication device associated with a plurality of predetermined types of device events and displaying the historical information of at least one type of device event of the plurality of predetermined types of device events.

16 The method of claim 15 wherein the historical information is displayed at a time when a device event is not detected.

17 The method of claim 16 further comprising the step of:
selectively removing historical information of a device event from the display.

18 The method of claim 14 further comprising the steps of:
determining the type of device event of the detected device event from among a plurality of predetermined types of device events;
determining if, during a detected device event, the usage of the wireless device is close to exceeding a predetermined amount of available usage of the wireless device for the type of device event of the detected device event; and
providing an alarm to the operator indicating that the usage of the wireless device for the detected device event is close to exceeding the predetermined amount of available usage for the type of device event of the detected device event.

19 The method of claim 18 wherein the alarm is at least one of an audio alarm, a visual alarm and a voice alarm.

20. The method of claim 18 wherein the method further comprises continuously counting down the remaining usage available for the type of device event of the detected device event during the occurrence of the device event, and providing a first alarm to the operator of the wireless communication device when the remaining usage available for the type of device event of the detected event is less than or equal to a first threshold.

21. The method of claim 20, further comprising providing a second alarm to the operator of the wireless communication device when the remaining usage available for the type of device event of the detected event is less than or equal to a second threshold, the second threshold being less than the first threshold.

22. The method of claim 18, further comprising prompting the operator to call a service provider to request additional available usage of the wireless communication device for the types of device event of the detected device event when the usage of the wireless device is close to exceeding a predetermined amount of available usage of the wireless device for the type of device event of the detected device event.

23. The method of claim 18, wherein the plurality of predetermined types of device events include at least one of: a voice event, a data event, a gaming event, an Internet event, and an operator selected internal activity event.

24. The method of claim 23, wherein a voice event includes an audio communication during at least one of predefined periods of: peak minutes, off peak minutes, weekday minutes, daytime minutes, anytime minutes, evening minutes, nighttime minutes, mobile to mobile minutes, rollover minutes, shared minutes, local minutes, long distance minutes, and roaming minutes.

25. The method of claim 24, further comprising the step of detecting and monitoring at least one period of the predefined periods, and providing historical information of the usage of each type of voice event.

26. The method of claim 18, wherein an operator selected internal activity includes at least one of remaining battery charge and music played by the wireless communication device, and at least one of minutes of remaining battery charge and music played are displayed on the display.

27. A computer readable medium containing a program capable of causing a computer to perform a method of monitoring usage of a wireless communication device comprising the steps of:
detecting a device event of the wireless communication device;
monitoring an available usage of the wireless communication device during the occurrence of the detected device event; and
continuously displaying the available usage of the wireless communication device during the occurrence of the device event and after the termination of the device event.

28. The computer readable medium of claim 27, wherein the method further comprises the steps of:
providing historical information indicative of the usage of the wireless communication device associated with a plurality of predetermined types of device events and displaying the historical information of at least one type of device event of the plurality of predetermined types of device events.

29. The computer readable medium of claim 28, wherein the historical information is displayed at a time when a device event is not detected.

30. The computer readable medium of claim 29, wherein the method further comprises the steps of:
selectively removing historical information of a device event from the display.

31. The computer readable medium of claim 27, wherein the method further comprises the steps of:
determine the type of device event of the detected device event from among a plurality of predetermined types of device events;
determining if, during a detected device event, the usage of the wireless device is close to exceeding a predetermined amount of available usage of the wireless device for the type of device event of the detected device event, and
providing an alarm to the operator indicating that the usage of the wireless device for the detected device event is close to exceeding the predetermined amount of available usage for the type of device event of the detected device event.

32. The computer readable medium of claim 31, wherein the alarm is at least one of an audio alarm, a visual alarm and a voice alarm.

33. The computer readable medium of claim 31, wherein the method further comprises continuously counting down the remaining usage available for the type of device event of the detected device event during the occurrence of the device event, and providing a first alarm to the operator of the wireless communication device when the remaining usage available for the type of device event of the detected event is less than or equal to a first threshold.

34. The computer readable medium of claim 33, wherein the method comprises the steps of providing a second alarm to the operator of the wireless communication device when the remaining usage available for the type of device event of the detected event is less than or equal to a second threshold, the second threshold being less than the first threshold.

35. The computer readable medium of claim 31, wherein the method comprises the steps of prompting the operator to call a service provider to request additional available usage of the wireless communication device for the types of device event of the detected device event when the usage of the wireless device is close to exceeding a predetermined amount of available usage of the wireless device for the type of device event of the detected device event.

36. The computer readable medium of claim 31, wherein the plurality of predetermined types of device events include at least one of: a voice event, a data event, a gaming event, an Internet event, and an operator selected internal activity event.

37. The computer readable medium of claim 36, wherein a voice event includes an audio communication during at least one of predefined periods of: peak minutes, off peak minutes, weekday minutes, daytime minutes, anytime minutes, evening minutes, nighttime minutes, mobile to mobile minutes, rollover minutes, shared minutes, local minutes, long distance minutes, and roaming minutes.

38. The computer readable medium of claim 37, wherein the method further comprising the step of detecting and monitoring at least one period of the predefined periods, and providing historical information of the usage of each type of voice event.

39. The computer readable medium of claim 31, wherein an operator selected internal activity includes at least one of remaining battery charge and music played by the wireless communication device, and at least one of minutes of remaining battery charge and music played are displayed on the display.
